(19) United States
(12) Patent Application Publication
(10) Pub. No.: US 2012/0104293 A1
(43) Pub. Date: May 3, 2012

(54) PRESSURE CONTROL VALVE, IN PARTICULAR FOR AN AUTOMATIC TRANSMISSION IN A MOTOR VEHICLE

(76) Inventors: Walter Fleischer, Stuttgart (DE); Tilo Hofmann, Tamm (DE); Andrzej Pilawski, Vaihingen/Enz (DE); Klaus Schudt, Nordheim (DE); Christof Ott, Asperg (DE)

(21) Appl. No.: 13/138,759

(22) PCT Filed: Feb. 18, 2010
(86) PCT No.: PCT/EP2010/052035

§ 371 Date: Dec. 29, 2011

(30) Foreign Application Priority Data
Mar. 31, 2009 (DE) 10-2009-002-003.9

(51) Int. Cl. F16K 31/02

(52) U.S. Cl. 251/129.01

(57) ABSTRACT

A pressure control valve for an automatic transmission in a motor vehicle includes a housing, a valve slide which is guided in the housing and which has multiple adjacent sections, a first section having a first diameter, a second section adjacent thereto having a second diameter smaller than the first diameter, and a third section having the first diameter adjacent to the second section. An inflow pressure opening is assigned to the first section, a control pressure opening is assigned to the second section and a return flow opening is assigned to the third section. An electromagnetic actuating device acts upon the valve slide via a piston, which is guided pressure-tight in the housing.

### BACKGROUND OF THE INVENTION

1. Field of the Invention

The present invention relates to a pressure control valve, in particular for an automatic transmission in a motor vehicle.

2. Description of Related Art

A pressure control valve of the aforementioned type is known from U.S. Patent Application Publication No. US 2007/0023722 A1. The pressure control valve described therein has a valve slide which is guided in a bore having a constant diameter. The valve slide is coupled with an electromagnetic actuating device via an actuating piston. In the known pressure control valve, an application device designed as a helical spring acts upon the valve slide against the direction of action of the electromagnetic actuating device. However, the control performance of the known pressure control valve is unsatisfactory, and the manufacture of the individual components is expensive.

### BRIEF SUMMARY OF THE INVENTION

An object of the present invention is to provide a pressure control valve which offers high control quality and, at the same time, is economical to manufacture.

In the pressure control valve according to the present invention, the force which acts upon the valve slide against the first direction of action depends on the pressure instantaneously prevailing at the control pressure opening. If the pressure at the control pressure opening drops, the force acting upon the valve slide against the first direction of action is also reduced, whereby the valve slide is moved in the direction of action. However, if the pressure prevailing at the control pressure opening increases, the force acting upon the valve slide against the first direction of action also increases, whereby it moves against the first direction of action. This self-control function of the valve slide is achieved by the fact that the pressure prevailing at the control pressure opening prevails in the two pressure chambers which are delimited by the diametrically opposed end faces of the valve slide; however, the hydraulic surface acting in the direction of action differs from the hydraulic surface acting against the first direction of action.

This difference between the hydraulic surfaces acting against and in the first direction of action is achieved by the piston, which couples the electromagnetic actuating device with the valve slide. Since this piston is guided pressure-tight in the housing, and only ambient pressure or return pressure or the like is applied to its end which faces away from the valve slide, the surface difference addressed above is provided exactly by the cross section of the piston. An additional pressure sensing pin, which engages with the second end face and whose force acting upon the valve slide depends on the pressure prevailing at the control pressure opening, is not necessary.

All in all, a pressure control valve is obtained by the present invention, which provides a precise self-control function and simultaneously ensures a simple structural design and correspondingly low manufacturing costs.

In a first refinement of the pressure control valve according to the present invention, the pressure control valve includes at least one channel which is situated outside the valve slide and which connects at least one of the pressure chambers to the control pressure opening. The advantages according to the present invention may thus be achieved even if the pressure control valve has a highly compact design, without the establishment of the fluid connection between the pressure chambers and the control pressure opening resulting in a particular degree of complexity. The advantages according to the present invention may possibly be achieved even in a pressure control valve of an essentially conventional design if the fluid connection according to the present invention between the two pressure chambers and the control pressure opening is established, for example, by a channel implemented in the automatic transmission. Otherwise, one option is to establish the fluid connection with the aid of a channel guided in the housing.

As an alternative or in addition thereto, it is possible for at least one channel to be present in the valve slide which connects at least one of the pressure chambers to the control pressure opening. The advantage of this refinement is that no restructuring is necessary, for example at the automatic transmission, since the outer dimensions and ports of the pressure control valve remain unchanged. Even the housing of the pressure control valve may, if necessary, remain largely unchanged, since it is enough to replace the valve slide with one which has a channel and to seal the two pressure chambers toward the outside, for example, with the aid of corresponding plugs.

The channel may be situated eccentrically to the longitudinal axis of the valve slide. The piston of the electromagnetic actuating device is thus able to engage in the center of the end face, which avoids tilting torques and unilateral wear, without blocking the channel. A simple variant for connecting the channel to the control pressure opening is to implement a corresponding transverse opening in the valve slide.

In a refinement thereof, it is proposed that the first end face is formed at least partially on a pressure piece which is connected to a base member of the valve slide and into which the channel opens. This is particularly advantageous if the channel is formed simply by the fact that the valve slide is a sleeve-like part in the shape of a hollow cylinder, since in such a case, in particular, the manufacture of the end area with which the piston engages is simplified, thereby lowering the costs. A pressure piece which is designed as a punched and bent part is particularly cost-effective.

As an alternative thereto, the first end face may also be at least partially designed as a base which forms a single piece with the valve slide and into which the channel opens. Since the piston usually engages in the center of the valve slide to avoid tilting torques and consequently uneven wear as well as undefined leakage, the opening of the channel should be eccentric. In a valve slide manufactured from a solid material, the channel may be easily provided, for example, by an off-center through-hole which is fluid-connected to the control pressure opening by a corresponding transverse bore.

The piston may also at least partially be formed as a single piece with the valve slide. Although this slightly increases the manufacturing complexity, since the manufacturing precision requirements for guiding the valve slide within the housing and for guiding the piston within the housing, should such a guide be provided, are increased; conversely, however, an additional guide is provided and the number of parts to be handled separately is reduced.

### BRIEF DESCRIPTION OF THE DRAWINGS

FIG. 1 shows a schematic representation of an automatic transmission and an associated hydraulic circuit having a pressure control valve.

FIG. 2 shows a partial section of the pressure control valve from FIG. 1.

FIG. 3 shows a representation, similar to FIG. 2, of a first alternative specific embodiment.

FIG. 4 shows a representation, similar to FIG. 2, of a second alternative specific embodiment.

### DETAILED DESCRIPTION OF THE INVENTION

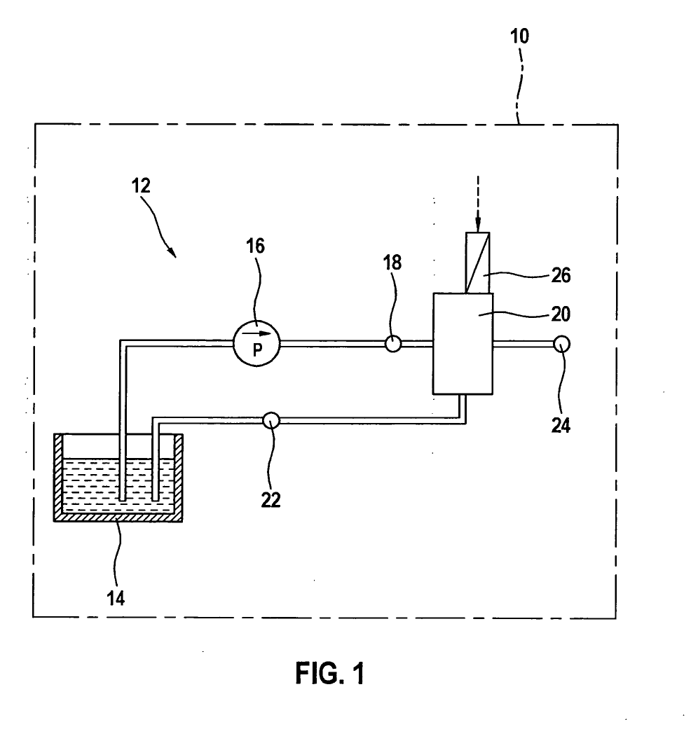

An automatic transmission in a motor vehicle is illustrated in FIG. 1 by a dot-dash box, which is identified as a whole by reference numeral 10.

Among other things, a hydraulic circuit 12, to which an unpressurized hydraulic reservoir 14 and a hydraulic pump 16 belong, is used to control automatic transmission 10. An outlet of hydraulic pump 16 forms a supply port 18, to which a pressure control valve 20 is connected.

From pressure control valve 20, a return flow which returns to hydraulic reservoir 14 flows to a return flow port 22. Furthermore, pressure control valve 20 is connected to a working port 24 at which the pressure to be controlled by pressure control valve 20 is present. In addition, pressure control valve 20 has an electromagnetic actuating device 26.

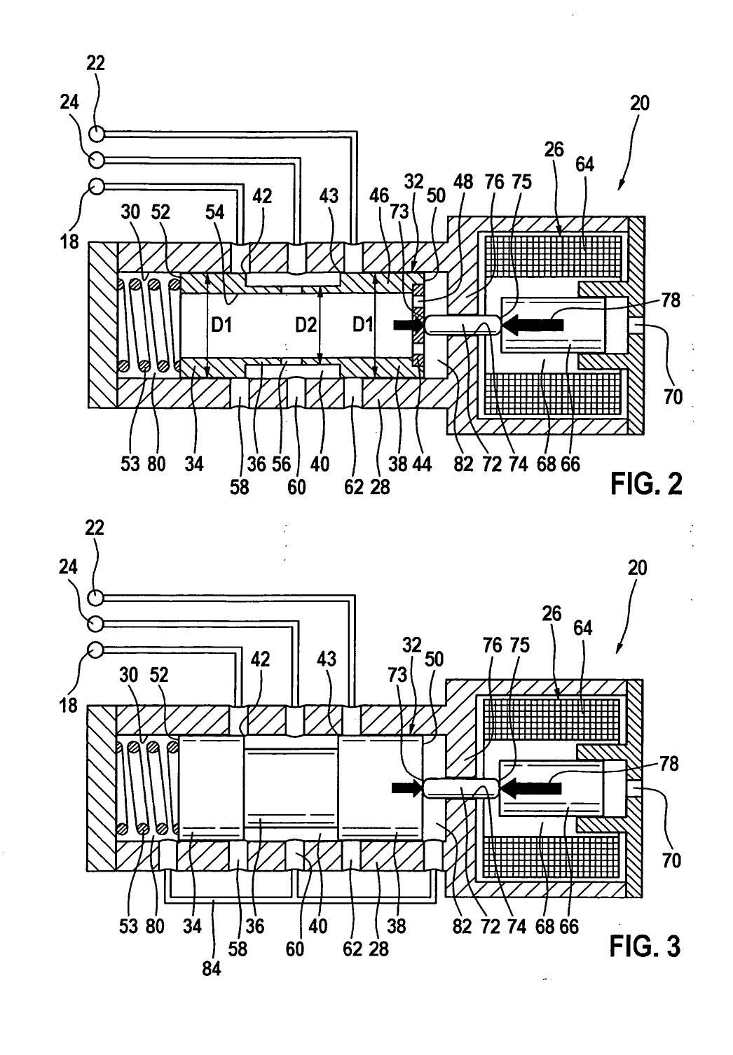

As shown in FIG. 2, pressure control valve 20 is structured as follows: It includes a sleeve-like housing 28, in which a guide bore 30 for an equally sleeve-like hollow valve slide 32 is present. Valve slide 32 has three adjacent sections 34, 36 and 38 in the axial direction. Outermost left-hand and first section 34 in FIG. 2 has a first diameter D1 which corresponds approximately to the inner diameter of guide bore 30. The approximately centered second section 36, which adjoins first section 34, has a second diameter D2 which is smaller than first diameter D1. Third section 38, which adjoins second section 36, again has first diameter D1. Since guide bore 30 has the same inner width all over, an annular chamber 40 is formed between the guide bore of housing 28 and second section 36 of valve slide 32. The edge of first section 34 which faces second section 36 forms a control edge 42 whose function is discussed in greater detail below. The edge of the third section which faces second section 36 forms a control edge 43.

As mentioned above, valve slide 32 has a hollow interior. While it is completely open on its left-hand end in FIG. 2, a disk-shaped pressure piece 44, which is designed as a punched and bent part, is provided in the right-hand end of the slide valve in FIG. 2. Pressure piece 44 is pressed into a corresponding receptacle (without a reference numeral) of a base member 46 of valve slide 32, where it is undetachably held in place. Pressure piece 44 has a plurality of off-center through-openings 48. The outside of pressure piece 44 and an annular outside of base member 46 adjacent thereto form a first end face 50 of valve slide 32. A diametrically opposed, ring-shaped second end face 52 is provided on the opposite end of base member 46. An application device in the form of a helical compression spring 53 engages therewith and is supported on an end plate (without a reference numeral) of housing 28, with the aid of which guide bore 30 is sealed.

The cavity in the interior of valve slide 32 forms a channel 54, whose function is likewise discussed in further detail below. Channel 54 is connected to annular chamber 40 via transverse bores 56 in the area of second section 36. An inflow pressure opening 58 is assigned to first section 34 of valve slide 32 in housing 28, a control pressure opening 60 is assigned to second section 36 and a return flow opening 62 is assigned to third section 38. Inflow pressure opening 58 is connected to supply port 18, control pressure opening 60 is connected to working port 24 and return flow opening 62 is connected to return flow port 22.

In FIG. 2, electromagnetic actuating device 26 is situated on the right-hand side of pressure control valve 20. It includes, among other things, an annular coil 64 and a centrally situated armature 66. A chamber 68, in which armature 66 is accommodated, is connected to an unpressurized outer chamber (no reference numeral) by a vent opening 70. A pin-shaped piston 72, whose end faces 73 and 75 have a spherical design in the present specific embodiment, is situated between armature 66 and pressure piece 44 to provide an ideally centric force application point, i.e., one which lies on the longitudinal axis of the valve slide. End face 73 of piston 72 facing pressure piece 44 rests against pressure piece 44, while end face 75 of piston 72 facing armature 66 rests against armature 66. Piston 72 is guided fluid-tight in a through-opening 74 in a housing wall 76 which separates guide bore 30 from armature chamber 68.

During operation, electromagnetic actuating device 26 acts upon valve slide 32 via piston 72 in a first direction of action, which is indicated by an arrow 78 in FIG. 2. Helical compression spring 53 acts upon valve slide 32 against this first direction of action 78.

Pressure control valve 20 operates as follows: When valve slide 32 is in a rather left-hand position in FIG. 2, hydraulic oil flows under high pressure from supply port 18 and inflow pressure opening 58 into annular chamber 40 and from there to working port 24 via control pressure opening 60. Return flow opening 62 is largely covered by control edge 43; return flow opening 62 is thus largely separated from annular chamber 40. However, if valve slide 32 is in a rather right-hand position, inflow pressure opening 58 in housing 28 is covered by control edge 42, and annular chamber 40 is thus largely separated from inflow pressure opening 58. Instead, control edge 43 now releases return flow opening 62 so that control pressure opening 60 communicates with return flow opening 62. In this manner, control pressure opening 60 is able to communicate more or less with inflow pressure opening 58 and/or with return flow opening 62.

The position of valve slide 32 results from the equilibrium of forces between the hydraulic forces acting upon valve slide 32 and piston 72, on the one hand, and the force applied to valve slide 32 by electromagnetic actuating device 26 via piston 72, on the other hand, as well as the force present at valve slide 32, due to helical spring 53. In the specific embodiment illustrated in FIG. 2, valve slide 32 is pressure-equalized, i.e., the sum of the hydraulic forces applied thereto is approximately zero. A pressure chamber 80, which is provided to the left of valve slide 32 in FIG. 2 and in which helical compression spring 53 is situated, communicates namely with control pressure opening 60 via channel 54 and transverse bores 56, as does a pressure chamber 82, which is provided to the right of pressure piece 44 in FIG. 2, the latter pressure chamber communicating with control pressure opening 60 via through-openings 48 in pressure piece 44, channel 54 and transverse bores 56. The control pressure prevailing at working port 24 or in control pressure opening 60 thus also prevails in both pressure chambers 80 and 82.

Since piston 72 enters pressure chamber 82, the control pressure also acts upon end face 73, while the ambient pressure prevailing in chamber 68 is applied to end face 75 oriented in the opposite direction. Control pressure is therefore applied to piston 72 against first direction of action 78. In this manner, not only the force generated by electromagnetic actuating device 26 in first direction of action 78 acts upon valve slide 32, but also a force which is reduced by the force hydraulically generated by the control pressure at end face 73 and acting against first direction of action 78. When the pressure at control pressure opening 60 decreases, the force acting upon valve slide 32 to the left in FIG. 2 increases; when the pressure prevailing at control pressure opening 60 increases, the force acting upon valve. slide 32 to the left in FIG. 2 decreases. A self-control function of valve slide 32 is provided thereby without requiring an additional piston (“pressure sensing pin”).

An alternative specific embodiment is illustrated in FIG. 3. In this discussion and below, elements and areas whose functions are equivalent to elements and areas which were already described in connection with a preceding figure are identified by the same reference numerals and are not explained again in further detail.

In pressure control valve 20 illustrated in FIG. 3, valve slide 32 is not designed as a hollow part but as a piston made from a solid material. The connection between the two pressure chambers 80 and 82 and control pressure opening 60 is therefore provided by an external channel 84. For example, it may be provided in a structure into which pressure control valve 20 is inserted.

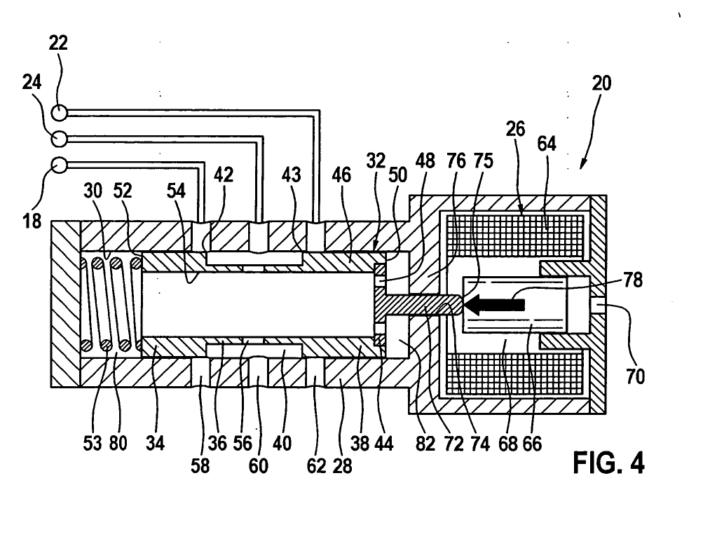

In a further specific embodiment illustrated in FIG. 4, valve slide 32 is hollow, according to the specific embodiment illustrated in FIG. 2. However, piston 72 is not designed as a separate part but forms a single piece with pressure piece 44. The control function according to the pressure prevailing at control pressure opening 60 is provided by the fact that an area of pressure piece 44 which corresponds to the cross section of piston 72 is “shaded,” i.e., the control pressure prevailing in pressure chamber 82 cannot be applied thereto.

1-9. (canceled)

10. A pressure control valve for an automatic transmission in a motor vehicle, comprising:
a housing;
a valve slide guided in the housing, wherein the valve slide has a first section having a first diameter, a second section adjacent to the first section and having a second diameter which is smaller than the first diameter, and a third section adjacent to the second section and having the first diameter, and wherein an inflow pressure opening is assigned to the first section, a control pressure opening is assigned to the second section, and a return flow opening is assigned to the third section;
an electromagnetic actuating device configured to act upon the valve slide via a piston which (i) engages with a first end face of the valve slide and (ii) is guided pressure-tight in the housing at least in a first direction of action; and
an application device configured to act upon the valve slide against the first direction of action;
wherein the first end face of the valve slide delimits a first pressure chamber, and a diametrically opposed second end face delimits a second pressure chamber, each of the first and second pressure chambers being fluid-connected to the control pressure opening.

11. The pressure control valve as recited in claim 10, wherein at least one channel which is situated outside the valve slide connects at least one of the first and second pressure chambers to the control pressure opening.

12. The pressure control valve as recited in claim 10, wherein at least one channel is provided in the valve slide and connects at least one of the first and second pressure chambers to the control pressure opening.

13. The pressure control valve as recited in claim 12, wherein the channel is configured as an eccentric longitudinal bore.

14. The pressure control valve as recited in claim 12, wherein the channel is hydraulically connected to the control pressure opening via a transverse opening.

15. The pressure control valve as recited in claim 12, wherein the first end face is formed at least partially on a pressure piece which is connected to a base member of the valve slide, and wherein the channel opens onto the pressure piece.

16. The pressure control valve as recited in claim 15, wherein the pressure piece includes a punched and bent part.

17. The pressure control valve as recited in claim 12, wherein the first end face is configured at least partially as a base which forms a single piece with the valve slide, and wherein the channel opens onto the base.

18. The pressure control valve as recited in claim 12, wherein the piston is at least partially formed as a single piece with the valve slide.
